(19) United States
(12) Patent Application Publication
(10) Pub. No.: US 2018/0017809 A1
(43) Pub. Date: Jan. 18, 2018

(54) EYEGLASSES

(71) Applicant: CONTOUR OPTIK INC., Minxiong Township (TW)

(72) Inventor: Zhao-Yun HE, Shenzhen (CN)

(21) Appl. No.: 15/649,039

(22) Filed: Jul. 13, 2017

(30) Foreign Application Priority Data
Jul. 18, 2016 (CN) 201610569959.6

(51) Int. Cl. G02C 5/02; G02C 5/12; B29D 11/00

(52) U.S. Cl. CPC G02C 5/02; G02C 5/12; B29D 11/00009

(57) ABSTRACT

Eyeglasses include two lenses and a frame unit. Each lens is integrally formed as one piece by injection molding, and includes a lens body, and a nose side protrusion and an ear side protrusion extending oppositely and respectively from two opposite lateral ends of the lens body. The frame unit includes a bridge and two end pieces. The bridge has a bridge body, and two nose side fixing portions respectively formed on two opposite ends of the bridge body and respectively connected to the nose side protrusions of the lenses. Each end piece has a lens connecting end connected to the ear side protrusion of a respective lens.

### CROSS-REFERENCE TO RELATED APPLICATION

This application claims priority of Chinese Patent Application No. 201610569959.6, filed on Jul. 18, 2016.

### FIELD

The disclosure relates to eyeglasses, more particularly to rimless or semi-rimless eyeglasses.

### BACKGROUND

Currently existing rimless eyeglasses usually require the lenses thereof to be provided with a plurality of through holes for respective connection with screws to fix the lenses on a frame. However, boring of holes in the lenses may easily cause breakage of the lenses, leading to an increase in the manufacturing costs thereof. Currently existing semi-rimless eyeglasses has two half-rims, each of which is provided with a transparent connecting wire to forma frame for surrounding and fixing a lens. However, the manufacture thereof is complicated.

Rimless eyeglasses, as disclosed in U.S. Pat. No. 8,613,515B2, use an engaging method to fix a lens and a frame thereof. The lens has a lens body and an engaging portion extending from the lens body. The frame has a slotted spring lock for engagement with the engaging portion. However, the engaging portion of the lens must have a concave-convex structure to engage with the slotted spring lock, so that the contour thereof is complicated and the structure of the slotted spring lock is also complicated. Hence, the manufacture of the rimless eyeglasses is difficult.

### SUMMARY

Therefore, an object of the present disclosure is to provide eyeglasses that can be easily manufactured.

According to one aspect of this disclosure, the eyeglasses include at least one lens and a frame unit. The at least one lens is integrally formed as one piece by injection molding, and includes a lens body, and at least one protrusion protruding outwardly from a lateral end of the lens body. The frame unit is connected to the at least one lens and has at least one fixing portion fixedly connected to the at least one protrusion.

According to another aspect of this disclosure, the eyeglasses include two lenses and a frame unit. Each lens is integrally formed as one piece by injection molding, and includes a lens body, and a nose side protrusion and an ear side protrusion extending oppositely and respectively from two opposite lateral ends of the lens body. The frame unit includes a bridge and two end pieces. The bridge has a bridge body, and two nose side fixing portions respectively formed on two opposite ends of the bridge body and respectively connected to the nose side protrusions of the lenses. Each end piece has a lens connecting end connected to the ear side protrusion of a respective one of the lenses.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view of the first embodiment of eyeglasses according to the present disclosure;

FIG. 2 is a fragmentary partial sectional view of the first embodiment, illustrating how nose side protrusions of lenses are fixed to nose side fixing portions of a bridge by fasteners;

FIG. 3 is an exploded perspective view of the second embodiment of eyeglasses according to the present disclosure;

FIG. 4 is an exploded perspective view of the third embodiment of eyeglasses according to the present disclosure; and

FIG. 5 is an enlarged fragmentary sectional view of the third embodiment, illustrating a connection between a half-rim and a lens.

### DETAILED DESCRIPTION

Before the present disclosure is described in greater detail with reference to the accompanying embodiments, it should be noted herein that like elements are denoted by the same reference numerals throughout the disclosure.

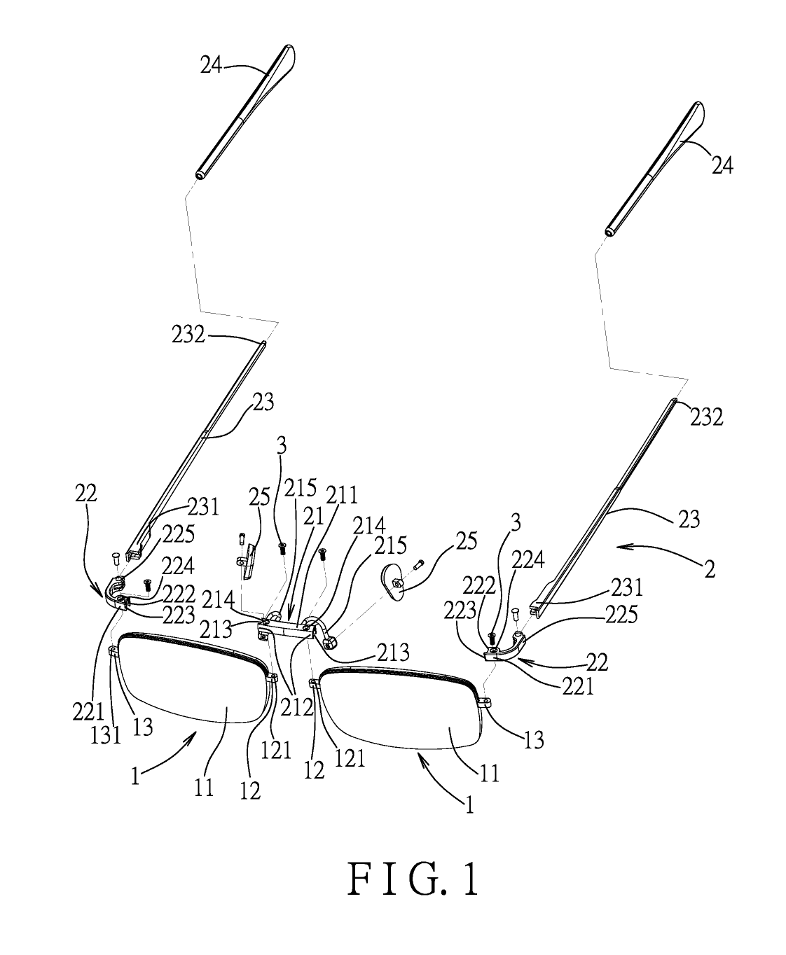

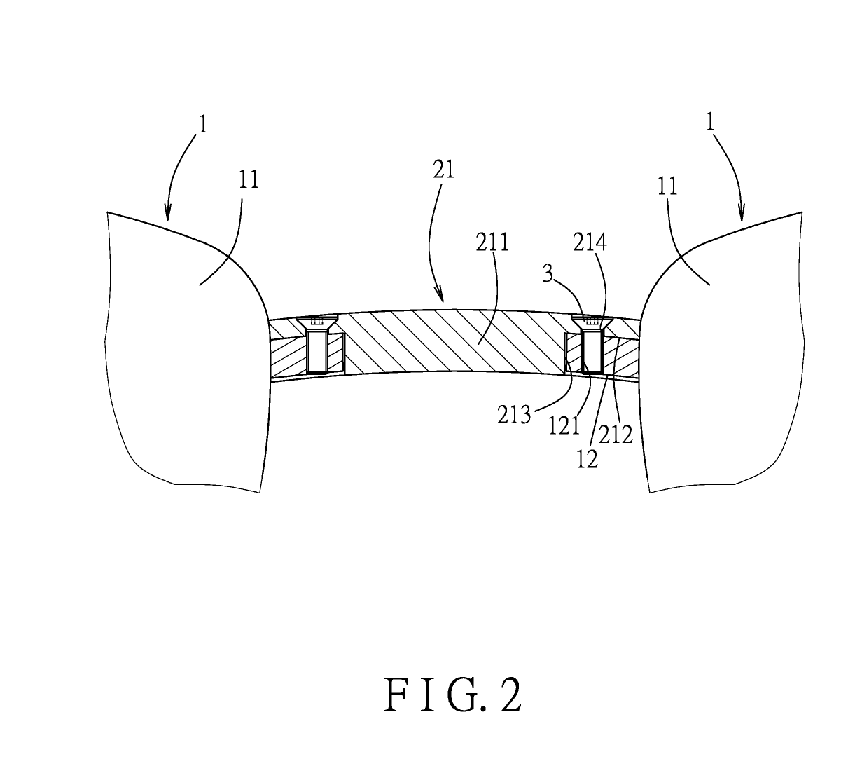

Referring to FIGS. 1 and 2, the first embodiment of eyeglasses according to the present disclosure is shown to include two lenses 1 and a frame unit 2.

Each lens 1 is integrally formed as one piece by injection molding, and includes a lens body 11, and a nose side protrusion 12 and an ear side protrusion 13 extending oppositely and respectively from two opposite lateral ends of the lens body 11. The nose side protrusion 12 has a first fixing hole 121, while the ear side protrusion 13 has a second fixing hole 131.

The frame unit 2 includes a bridge 21, two end pieces 22, two temples 23, two temple sleeves 24 and two nose pads 25. The bridge 21 has a bridge body 211, and two nose side fixing portions 212 respectively formed on two opposite ends of the bridge body 211. Each nose side fixing portion 212 defines a first groove 213 receiving the nose side protrusion 12 of a respective one of the lenses 1, and has a first through hole 214 communicating with the first groove 213. The first through hole 214 of each nose side fixing portion 212 is aligned with the first fixing hole 121 in the nose side protrusion 12 of the respective lens 1 for extension of a fastener 3 therethrough to fixedly fasten each nose side fixing portion 212 to the nose side protrusion 12 of the respective lens 1. Through this, the bridge 21 can be connected between the lenses 1.

Each end piece 22 has a lens connecting end 221 formed with an ear side fixing portion 222. The ear side fixing portion 222 of each end piece 22 defines a second groove 223 receiving the ear side protrusion 13 of the respective lens 1, and has a second through hole 224 communicating with the second groove 223. The second through hole 224 of the ear side fixing portion 222 of each end piece 22 is aligned with the second fixing hole 131 in the ear side protrusion 13 of the respective lens 1 for extension of another fastener 3 therethrough to fixedly fasten the ear side fixing portion 222 of each end piece 22 to the ear side protrusion 13 of the respective lens 1. Through this, the end pieces 22 can be connected to the ear side protrusions 13 of the respective lenses 1. Each end piece 22 further has a temple connecting end 225 opposite to the lens connecting end 221. Each temple 23 has a hinge end 231 hinged to the temple connecting end 225 of a respective one of the end pieces 22, and a tail end 232 opposite to the hinge end 231. Through this, the temples 23 can be connected to the lens connecting ends 221 of the respective end pieces 22. The temple sleeves 24 are respectively sleeved on the tail ends 232 of the temples 23. The bridge 21 further has two nose pad supports 215 extending oppositely and respectively from the bridge body 211. The nose pads 25 are respectively connected to the nose pad supports 215 and are supported by the same.

There is no need to form through holes in the lens bodies 11 of the lenses 1 during assembly of the lenses 1 and the frame unit 2, so that the risk of breaking the lens bodies 11 can be reduced. Further, since the connecting structure of the lenses 1 and the frame unit 2 is simple, manufacture and assembling of the components of the eyeglasses of this embodiment are easy.

In an alternative embodiment, the nose side protrusion 12 of each lens 1 may not have the first fixing hole, each nose side fixing portion 212 may not have the first through hole, the ear side protrusion 13 of each lens 1 may not have the second fixing hole, and each ear side fixing portion 222 may not have the second through hole. In this case, the nose side protrusion 12 of each lens 1 is interference-fitted to the first groove 213 of the respective nose side fixing portion 212, and the ear side protrusion 13 of each lens 1 is interference-fitted to the second groove 223 of the respective end piece 22. What is disclosed herein should not be imposed as an implementation limitation.

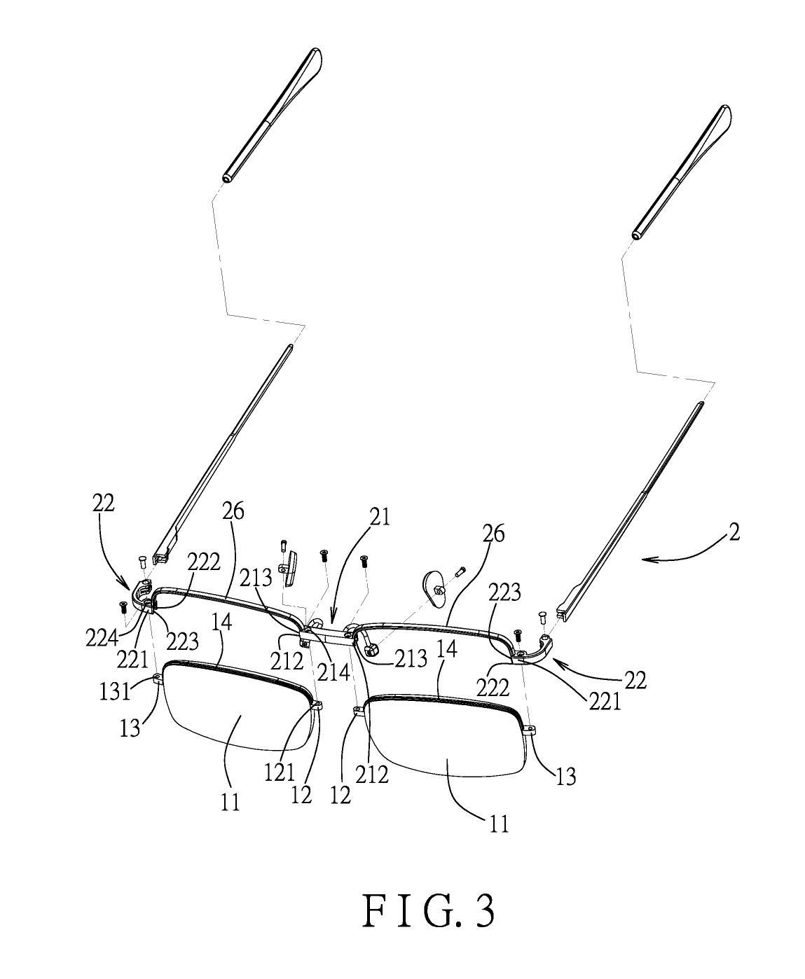

Referring to FIG. 3, the second embodiment of the eyeglasses according to this disclosure is generally identical to the first embodiment. Particularly, each nose side fixing portion 212 of the bridge 21 defines the first groove 213 receiving the nose side protrusion 12 of the respective lens 1, and each ear side fixing portion 222 of each end piece 22 defines the second groove 223 receiving the ear side protrusion 13 of the respective lens 1. However, in the second embodiment, the frame unit 2 further includes two half-rims 26, each of which is connected between one of the nose side fixing portions 212 of the bridge 21 and the lens connecting end 221 of the corresponding end piece 22. Each half-rim 26 is disposed on an upper end 14 of the lens body 11 of the respective lens 1 between the nose side protrusion 12 and the ear side protrusion 13 thereof.

In an alternative embodiment, each nose side fixing portion 212 may be a block body without the first groove, and by aligning the first through hole 214 in each nose side fixing portion 212 with the first fixing hole 121 in the nose side protrusion 12 of the respective lens 1, a fastener 3 may then be used to fixedly fasten each nose side fixing portion 212 to the nose side protrusion 12 of the respective lens 1. Similarly, each ear side fixing portion 222 may be a block body without the second groove, and by aligning the second through hole 224 in each ear side fixing portion 222 with the second fixing hole 131 in the ear side protrusion 13 of the respective lens 1, another fastener 3 may be used to fixedly fasten each ear side fixing portion 222 to the ear side protrusion 13 of the respective lens 1. What is disclosed herein should not be imposed as an implementation limitation.

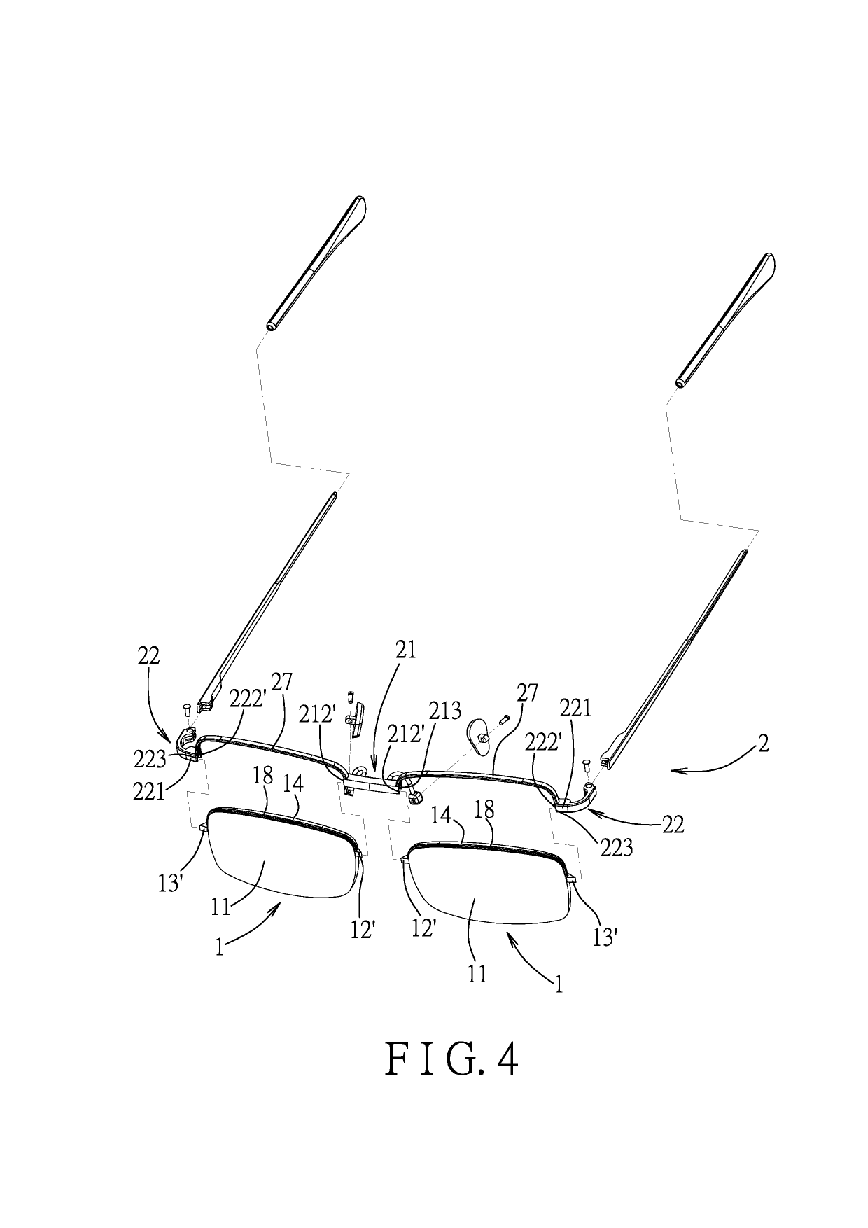

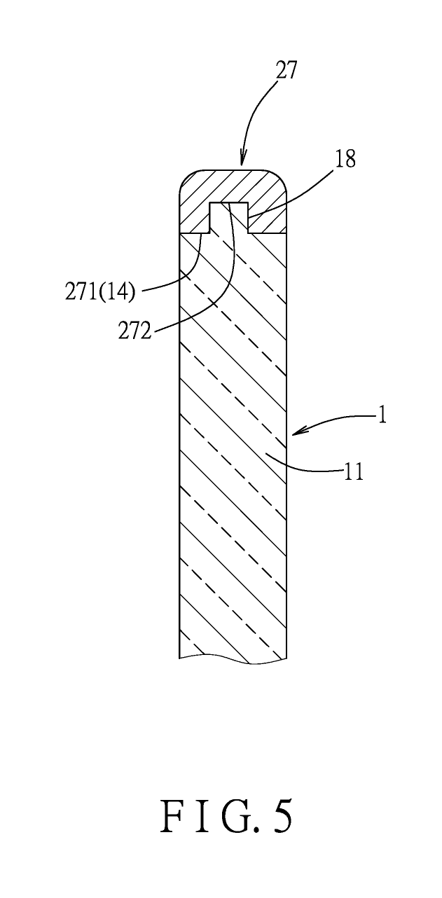

Referring to FIGS. 4 and 5, the third embodiment of the eyeglasses according to this disclosure is generally identical to the first embodiment. Particularly, each lens 1 includes a lens body 11, and a nose side protrusion 12′ and an ear side protrusion 13′ extending oppositely and respectively from two opposite ends of the lens body 11. Each nose side fixing portion 212′ of the bridge 21 defines a first groove 213. Each ear side fixing portion 222′ of each end piece 22 defines a second groove 223. However, in the third embodiment, the nose side protrusion 12′ of each lens 1 is interference-fitted to the first groove 213 of the respective nose side fixing portion 212′, and the ear side protrusion 13′ of each lens 1 is interference-fitted to the second groove 223 of the ear side fixing portion 222′ of the respective end piece 22. It should be noted herein that, in the third embodiment, the nose side protrusion 12′ of each lens 1 does not have the first fixing hole, the ear side protrusion 13′ of each lens 1 does not have the second fixing hole, each nose side fixing portion 212′ does not have the first through hole, and each ear side fixing portion 222′ does not have the second through hole.

The frame unit 2 of this embodiment further includes two half-rims 27, each of which is connected between one of the nose side fixing portions 212′ of the bridge 21 and the lens connecting end 221 of the corresponding end piece 22. Each half-rim 27 is disposed on an upper end 14 of the lens body 11 of the respective lens 1 between the nose side protrusion 12′ and the ear side protrusion 13′ thereof, and has an abutment surface 271 abutting against the upper end 14 of the lens body 11 of the respective lens 1, and a clamping groove 272 extending inwardly from the abutment surface 271 in a direction away from the lens body 11 of the respective lens 1.

Each lens 1 further includes an upper end protrusion 18 protruding from the upper end 14 of the lens body 11 between the nose side protrusion 12′ and the ear side protrusion 13′ thereof toward a respective one of the half-rims 27. The upper rim protrusion 18 of each lens 1 is interference-fitted to the clamping groove 272 of the respective half-rim 27. Hence, in this embodiment, there is no need to use fasteners 3 during assembly of the lenses 1 and the frame unit 2.

In an alternative embodiment, the eyeglasses of this disclosure may have only one single lens with only one protrusion. The frame unit may be adjusted to correspond to the single lens, and may have one fixing portion to connect with the protrusion of the single lens. What is disclosed herein should not be imposed as an implementation limitation.

In sum, the eyeglasses of this disclosure does not require boring of holes in the lens bodies 11 of the lenses 1, thereby reducing the risk of breaking the lens bodies 11 of the lenses 1. Moreover, the connecting structure between the lenses 1 and the frame unit 2 is simple, so that manufacture and assembling of the components of the eyeglasses of this disclosure are easy. Hence, the object of this disclosure may indeed be achieved.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. Eyeglasses comprising:
at least one lens integrally formed as one piece by injection molding, and including a lens body, and at least one protrusion protruding outwardly from a lateral end of said lens body; and
a frame unit connected to said at least one lens and having at least one fixing portion fixedly connected to said at least one protrusion.

2. Eyeglasses comprising:
two lenses, each of which is integrally formed as one piece by injection molding and each of which includes a lens body, and a nose side protrusion and an ear side protrusion extending oppositely and respectively from two opposite lateral ends of said lens body; and
a frame unit including a bridge and two end pieces, said bridge having a bridge body, and two nose side fixing portions respectively formed on two opposite ends of said bridge body and respectively connected to said nose side protrusions of said lenses, each of said end pieces having a lens connecting end connected to said ear side protrusion of a respective one of said lenses.

3. The eyeglasses as claimed in claim 2, wherein each of said nose side fixing portions of said bridge defines a first groove receiving said nose side protrusion of the respective one of said lenses, said lens connecting end of each of said end pieces being formed with an ear side fixing portion that defines a second groove receiving said ear side protrusion of the respective one of said lenses.

4. The eyeglasses as claimed in claim 3, wherein said nose side protrusion of each of said lenses has a first fixing hole, each of said nose side fixing portions of said bridge having a first through hole communicating with said first groove and aligned with said first fixing hole for extension of a fastener therethrough to fix each of said nose side fixing portions to said nose side protrusion of the respective one of said lenses, said ear side protrusion of each of said lenses having a second fixing hole, said ear side fixing portion of said lens connecting end of each of said end pieces having a second through hole communicating with said second groove and aligned with said second fixing hole for extension of another fastener therethrough to fix said ear side fixing portion of each of said end pieces to said ear side protrusion of the respective one of said lenses.

5. The eyeglasses as claimed in claim 2, wherein said nose side protrusion of each of said lenses has a first fixing hole, each of said nose side fixing portions of said bridge having a first through hole communicating with said first groove and aligned with said first fixing hole for extension of a fastener therethrough to fix each of said nose side fixing portions to said nose side protrusion of the respective one of said lenses, said ear side protrusion of each of said lenses having a second fixing hole, said ear side fixing portion of said lens connecting end of each of said end pieces having a second through hole communicating with said second groove and aligned with said second fixing hole for extension of another fastener therethrough to fix said ear side fixing portion of each of said endpieces to said ear side protrusion of the respective one of said lenses.

6. The eyeglasses as claimed in claim 2, wherein each of said end pieces further has a temple connecting end opposite to said lens connecting end, said frame unit further including two temples respectively connected to said temple connecting ends of said end pieces, each of said temples having a hinge end hinged to a respective one of said temple connecting ends, and a tail end opposite to said hinge end, said frame unit further including two temple sleeves respectively sleeved on said tail ends of said temples, and two nose pads connected to said bridge.

7. The eyeglasses as claimed in claim 6, wherein said frame unit further includes two half-rims, each of which is connected between one of said nose side fixing portions of said bridge and said lens connecting end of a corresponding one of said end pieces, each of said half-rims being disposed on an upper end of said lens body of the respective one said lenses between said nose side protrusion and said ear side protrusion thereof.

8. The eyeglasses as claimed in claim 7, wherein each of said nose side fixing portions of said bridge defines a first groove, said nose side protrusion of each of said lenses being interference-fitted to said first groove of a respective one of said nose side fixing portions, said lens connecting end of each of said end pieces being formed with an ear side fixing portion that defines a second groove, said ear side protrusion of each of said lenses being interference-fitted to said second groove of said ear side fixing portion of a respective one of said end pieces.

9. The eyeglasses as claimed in claim 7, wherein each of said half-rims has an abutment surface abutting against said upper end of said lens body of the respective one of said lenses, and a clamping groove extending inwardly from said abutment surface in a direction away from the respective one of said lens, each of said lenses further including an upper end protrusion protruding from said upper end of said lens bodybetween said nose side protrusion and said ear side protrusion thereof toward a respective one of said half-rims, said upper end protrusion of each of said lenses being interference-fitted to said clamping groove of a respective one of said half-rims.
